(19) United States
(12) Patent Application Publication
(10) Pub. No.: US 2014/0087146 A1
(43) Pub. Date: Mar. 27, 2014

(54) SELF-CORRUGATING LAMINATES AND CORRUGATED STRUCTURES FORMED THEREFROM

(71) Applicant: Eastman Chemical Company, Kingsport, TN (US)

(72) Inventors: Marcus David Shelby, Fall Branch, TN (US); Scott Allen Clear, Escondido, CA (US); Freddie Wayne Williams, Kingsport, TN (US); Alan Yee Heng Kwok, Arcadia, CA (US); Candace Michele Tanner, Kingsport, TN (US); Jennifer Lynne Stikeleather Peavey, Raleigh, NC (US); Jeffrey Todd Owens, Kingsport, TN (US); Peter Borden Mackenzie, Kingsport, TN (US)

(73) Assignee: Eastman Chemical Company, Kingsport, TN (US)

(21) Appl. No.: 14/032,577

(22) Filed: Sep. 20, 2013

Related U.S. Application Data
(60) Provisional application No. 61/706,434, filed on Sep. 27, 2012.

(51) Int. Cl. B32B 3/28

(52) U.S. Cl. CPC B32B 3/28
USPC 428/182

(57) ABSTRACT

Self-corrugating laminates are disclosed that include first and second non-shrinkable core layers bonded together in a grid of spaced bond points arranged substantially linearly along perpendicular horizontal and vertical bond point lines; and upper and lower shrinkable film layers, each having a primary axis of shrinkage and each bonded to one of the non-shrinkable core layers along bond lines that are substantially perpendicular to the primary axis of shrinkage of the immediately adjacent shrinkable film layer. Upon shrinkage of the upper and lower shrinkable film layers a corrugated structure is formed that includes first and second core layers each having spaced structural corrugations formed therein.

### RELATED APPLICATIONS

This application claims priority from U.S. Provisional Application No. 61/706,434, filed on Sep. 27, 2012, the entire disclosure of which is incorporated herein by reference.

### FIELD OF THE INVENTION

The present invention relates to laminates, and specifically, to self-corrugating laminates that are useful to form corrugated structures.

### BACKGROUND OF THE INVENTION

The ability to make structural or functional plastic panels is limited to just a few processes because of the low modulus of plastics in general, coupled with the difficulty of generating three-dimensionally-reinforced structures. The processes that are available are either labor-intensive (e.g. thermoforming and bonding) or require extensive tooling (e.g. twin wall sheet extrusion). Parts made by these methods are also typically limited to two-dimensions such as with panels and, once produced, tend to be bulky and cannot be easily shipped or packaged. It is also difficult to introduce functionality into these structures because the core material is not easily modified, being specific to the intended use. It would be an advance in the art to provide rigid, and optionally functional, structural panels that are easily produced and shipped, that may be formed as films and shipped as rolls, and that may then be expanded just prior to use to form structural corrugates. Although prior art corrugates are known in which shrinkable layers assist in forming corrugations, we have found conventional shrinkable materials unsuitable to more demanding applications in which regular, structural corrugations are required.

U.S. Pat. No. 2,607,104 discloses two-ply and three-ply woven corrugated fabrics that are said to be highly resilient in resisting lateral compression. The three-ply fabrics include a top and bottom fabric that can be shrunk or contracted in the same direction to a pronounced degree of about 50% when heated, so that the shrinking of the outer fabrics will corrugate the intermediate fabric. The two-ply fabrics simply omit one of the outer shrinkable fabrics of the three-ply construction, leaving a single fabric that can be shrunk or contracted and an intermediate fabric which is thereby corrugated.

U.S. Pat. No. 3,620,896 discloses a tape having at least two laminae of different coefficients of contraction joined to prevent interlamina relative movement during contraction. The contractable lamina, which may contract as much as 50 to 70 percent of its original stretched dimensions upon activation, is said to be sharply corrugated, resulting in a lack of structural rigidity needed for more demanding applications. The tapes disclosed are intended simply as devices for securing wire and cable bundles, and the like.

U.S. Pat. Nos. 3,574,109 and 3,655,502 disclose heat insulating laminates in which at least one metal foil and at least one thermoplastic resin film are bonded at a number of bonding points uniformly distributed throughout the surface. The material is heated to cause shrinkage of the resin film and wrinkling of the metal foil.

U.S. Pat. No. 3,796,307 discloses a corrugated package material in which corrugated fluting is attached to one or more sheets of heat shrinkable polymeric film. The heat shrinkable film is preferably on only one side of the corrugated fluting, but may be on both sides of the corrugated fluting. The package may be heated to shrink the polymeric film and tighten the corrugated fluting core.

U.S. Pat. No. 6,875,712 discloses a shrinkable protective material that includes a nonwoven fabric bonded to a shrinkable film by an adhesive that is applied to either the nonwoven fabric or the shrinkable film in a pre-determined pattern. Upon shrinking, the nonwoven fabric separates or releases from the film and forms cushions or pillows holding the film off of the surface being protected. Since the film shrinks and the non-woven fabric is said not to shrink in any appreciable amount, the portions of the non-woven fabric overlying the areas which are unbounded are said to gather up to form the raised portions.

U.S. Pat. No. 7,588,818 discloses a multi-layer composite sheet comprising a shrinkable layer intermittently bonded to a gatherable layer with the bonds separated by a specified distance, wherein the shrinkable layer can shrink and at the same time gather the gatherable layer between the bonds. Also disclosed is a process for preparing multi-layer composite sheets by intermittently bonding a shrinkable layer to a gatherable layer with the bonds separated by a specified distance and causing the shrinkable layer to shrink while at the same time gathering the gatherable layer between the bonds.

JP 6-115014A discloses a laminatable strip that has self-stretching properties and can be filled with gas on site without the use of an expanding gas or the like, wherein the strip is a highly self-stretchable strip that has an ultrahigh gas content and a stable structure after stretching.

JP 6-238800A discloses a laminate for forming a three-dimensional structure with holes wherein a low-heat-shrinkage sheet and a high-heat-shrinkage sheet are alternately laminated together via partially adhesive layers arranged at a pre-determined interval in a substantially striped pattern substantially perpendicular to the shrinkage direction of the high-heat-shrinkage sheet, the laminate being characterized in that the low-heat-shrinkage sheet and the high-heat-shrinkage sheet are laminated in at least five layers or more. A related patent document having the same inventor and filing date, JP 6238796, discloses a three-dimensional accurately formed laminated body, said to be useful for obtaining a strong and stable three-dimensional structure, that is made from a low-heat-shrinking sheet and a high-heat-shrinking sheet alternatingly laminated such that there exists a difference in shrinkage between the sheets in the vertical direction, the sheets being interposed by a plurality of substantially striped partial adhesive layers disposed at a specific spacing. The laminated body is characterized in that the low-heat-shrinking sheet and the high-heat-shrinking sheet are five or more layers in total, and the partial adhesive layers are disposed alternatingly on an obverse and reverse side of the low-heat-shrinking sheet such that the spacing sequentially increases or decreases.

There remains a need in the art for improved film laminates that form structural corrugations by controlled contraction of shrinkable film layers, and especially those that form well defined corrugations in which at least two adjacent layers are provided with corrugations arranged along lines that are substantially perpendicular to one another. Such a structure would provide improved flexural stiffness in both the machine and transverse directions.

### SUMMARY OF THE INVENTION

The present invention relates to self-corrugating laminates that include first and second non-shrinkable core layers each with an exposed surface, bonded together in a grid of spaced bond points arranged substantially linearly along perpendicular horizontal and vertical bond point lines; an upper shrinkable film layer having a primary axis of shrinkage bonded to the exposed surface of the non-shrinkable core layer along upper bond lines arranged substantially parallel to one another and substantially perpendicular to said primary axis of shrinkage of said upper shrinkable film layer; and a lower shrinkable film layer having a primary axis of shrinkage, bonded to the exposed surface of the second non-shrinkable core layer along lower bond lines arranged substantially parallel to one another and substantially perpendicular to said primary axis of shrinkage of said lower shrinkable film layer.

The present invention also relates to a corrugated structure formed from the self-corrugating laminate of the present invention. The corrugated structure includes first and second core layers each having spaced structural corrugations formed therein along lines of corrugation. The lines of corrugation for the structural corrugations in the first core layer are substantially perpendicular to the lines of corrugation of the structural corrugations in the second core layer.

Upon exposing the self-corrugating laminate to conditions sufficient to activate shrinkage of the upper and lower shrinkable film layers, each shrinkable film layer shrinks along its primary axis of shrinkage and causes structural corrugations to form in the adjacent non-shrinkable core layer to which it is bonded thereby forming the corrugated structure.

Further aspects of the invention are as disclosed and claimed herein.

### BRIEF DESCRIPTION OF THE DRAWINGS

FIG. 1 depicts an exploded perspective view of an embodiment of the self-corrugating laminate of the present invention.

FIG. 2 depicts top view of an embodiment of the self-corrugating laminate of the present invention (with hidden bond points, bond point lines and bond lines also shown).

FIG. 3 depicts a partial side edge elevational view of the self-corrugating laminate of the present invention.

FIG. 4 depicts a perspective view of the corrugated structure of the present embodiment after thermal shrinkage has occurred.

FIG. 5 depicts a partial edge elevational view of the corrugated structure of the present invention.

### DETAILED DESCRIPTION

Unless otherwise indicated, all numbers expressing quantities of ingredients, properties such as percent shrinkage, and the like used in the present specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons”, is intended to specifically include and disclose C1 and C5 hydrocarbons as well as C2, C3, and C4 hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

As used herein, the term “shrinkable film layer” means a film layer that is capable of shrinking, for example by heat shrinking. The term is not intended to be especially limiting, although we have found, as further described below, that a relatively small amount of shrinkage may yield the best results in terms of uniformity of the structural corrugations obtained. As further set out below, the shrinkage of the outer shrinkable film layers will be substantially uniaxial, defining a primary axis of shrinkage, but may also be somewhat biaxial, so long as the shrinkable film layer has a primary axis of shrinkage. The amount of shrinkage of such a biaxial material may vary throughout the surface of the film layer, and such variation may be matched to variations in the axes of shrinkage of adjacent shrinkable film layer, so long as the primary axes of shrinkage of the two outer shrinkable film layers are substantially perpendicular to one another. Any suitable film capable of shrinking, for example heat-shrinkable film, may be used according to the invention, as further described herein.

When we refer to an “axis of shrinkage” we mean the direction in which the shrinkable film layer shrinks or shortens when the shrinkable film layer is shrunk. In uniaxial film, there will be a single axis of shrinkage, and biaxial films will have two axes of shrinkage. As used herein, the term “primary axis of shrinkage” means the axis in which the greatest amount of shrinkage occurs (note that for equi-biax films the primary and secondary axes of shrinkage exhibit approximately the same levels of shrinkage such that either may be deemed “primary”).

As used herein, the term “non-shrinkable core layer” is not intended to exclude layers that shrink, but rather, to describe layers that shrink, if at all, substantially less than do the shrinkable film layers. In some embodiments, the non-shrinkable core layer may not shrink appreciably during use, while in others the non-shrinkable core layer may shrink to some extent, either uniformly or to correspond to a desired final shape which is obtained in combination with the appropriate spacing and placement of bond points, bond point lines and bond lines. In various aspects, the amount of linear shrinkage of the non-shrinkable core layer may be less than about 10%, or less than 5%, or less than 1%, or as further set out herein.

As used herein, the term “structural corrugations” means corrugations present in a core layer of the corrugated and formed through shrinking of the shrinkable film layers in the self-corrugating laminate of the present invention. These structural corrugations can be regular or periodic and are generally capable of providing structural integrity and/or load-bearing structural support and can be distinguished from weak and typically irregular and/or wavy lines that may be suitable, for example, to provide an insulating layer or bulk in cases where load-bearing structural support is not required, and the corrugations need not therefore be carefully controlled as is done according to the present invention. The phrase structural corrugation is further elaborated on below, in particular with respect to the description of aspect ratio (Hc/P).

With respect to number elements in the Figures, it will be understood by one of ordinary skill that terminology such as horizontal, vertical, x-direction, y-direction, upper and lower are used herein to describe relative orientation as shown in the Figures and that they are dependent on the drawing orientation and viewer perspective.

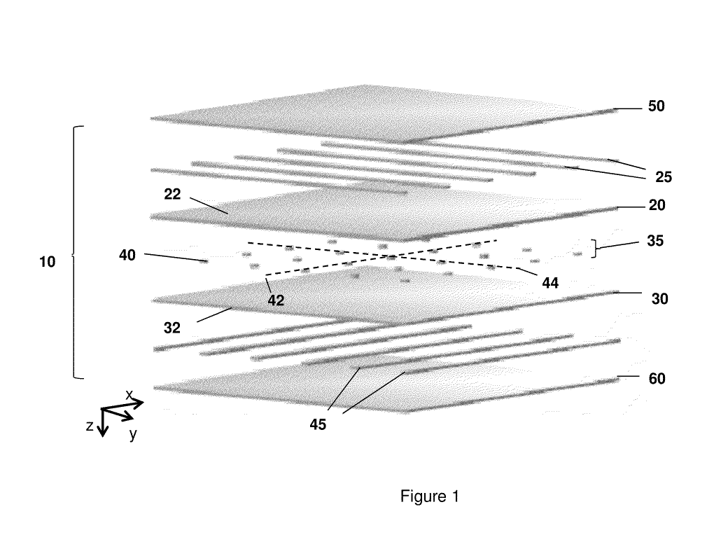

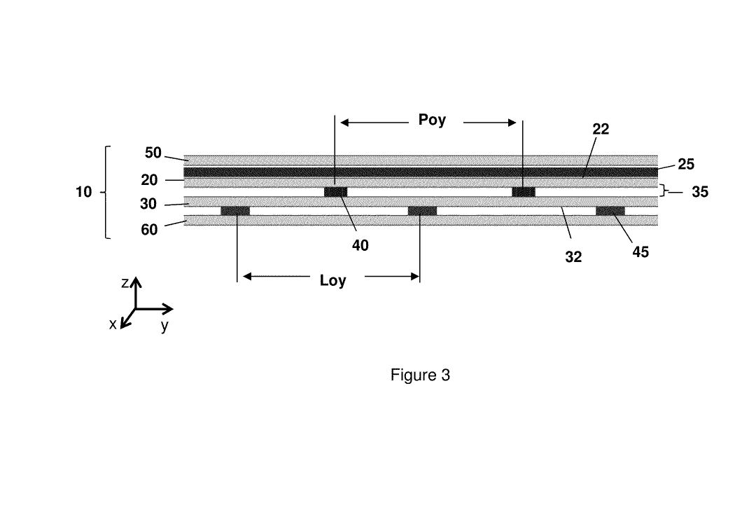

The present invention relates to self-corrugating laminates as generally show as 10 in FIGS. 1 through 3. Laminate 10 includes first and second non-shrinkable film core layers 20 and 30 each with an exposed surface 22 and 32 respectively and upper and lower shrinkable film layers 50 and 60 each with a primary axis of shrinkage as defined herein. First and second non-shrinkable core layers 20 and 30 are bonded together in a grid 35 of spaced bond points 40 that are arranged substantially linearly along horizontal bond point lines 42 and vertical bond point lines 44. Horizontal bond point lines 42 are generally perpendicular to vertical bond point lines 44.

In the Figures, the upper shrinkable layer 50 is shown as having a primary axis of shrinkage in the x-direction, whereas the primary axis of shrinkage for the lower shrinkable film layer 60 is shown in the y-direction. Preferably, the primary axis of shrinkage of the upper shrinkable film layer 20 is substantially normal to the primary axis of shrinkage of said lower shrinkable film layer 30. As used herein to describe the orientational relationship of the primary axes of shrinkage of the upper and lower shrinkable film layers, “normal” is defined as nonintersecting in parallel planes but oriented at approximately 90 degrees if superimposed. It should be understood that, when we say that the primary axes of shrinkage of the outer shrinkable film layers are oriented “substantially” normal to one another, we mean to include those cases in which the axes are absolutely normal as well as cases in which the axes may approximately be normal, and may vary along the length of a given axis, so long as the special orientation is sufficient to induce the desired structural corrugations.

A variety of materials can be used for the non-shrinkable core layers 20 and 30 or as described below any optional additional non-shrinkable film layers. The non-shrinkable core layers may be a plastic film such as a copolyester, polyester, acrylic, olefin, polycarbonate, polyimide, polyamide, styrenic, acetal, cellulose ester, urethane etc. It may be formed from a thermoset or a thermoplastic plastic, but is not limited to plastics, and may also be a metal foil, paper, a non-woven, a fabric, and so forth. The non-shrinkable core layers may also be selected or modified to provide a desired functionality or aesthetic or decorative features. For embodiments wherein shrinkage of the shrinkable film layers is activated by elevated temperature, it is preferred that the non-shrinkable core layers be formed from a material having a softening temperature near to or above the temperature of shrinkage of the shrinkable film layers. This is to prevent undesirable deformation of the core due to premature softening during the corrugation process. For non-shrinkable core layers formed from plastic, this softening temperature is usually denoted by the glass transition temperature Tg or the melt temperature Tm.

Typically, film or sheet extrusion may be used to form non-shrinkable core layers. This can be achieved, for example, by cast extrusion, sheet polishing, blown film, calendering, etc. There really is no limit as to how a non-shrinkable core layer is made. Typically, thicknesses will range from about 0.01 to 10 mm for each non-shrinkable layer, but even thicker values can be envisioned, particularly if the layer is formed from a lower modulus material (e.g. foams, rubbers). The film may also contain any of a number of normal additives and processing aids, colorants, pigments, stabilizers, antiblocks, etc. as long as these do not adversely affect subsequent bonding to the shrink layers. Multilayer coextruded or laminated structures can also be useful, particularly for adding additional functionality to the overall structure. The non-shrinkable core layers may optionally have texture or thickness variations imparted therein, for example using lenticular casting rolls, embossing, or post-extrusion modification. Examples include (i) a thin spot or cut in the non-shrinkable core layer at certain locations to allow for easier and more controlled buckling and (2) a continuous undulating variation imparted via lenticular embossing rolls. Having thin spots, cuts or grooves in the core layers can allow the core layers to buckle and form corrugations with less shrink force. This may be advantageous particularly with thicker non-shrinkable core layers. Grooves and embossed patterns can also be beneficial for aiding bonding along bond point lines with bond points formed with ultrasonic staking.

In a preferred embodiment wherein bond points are welds, the bond points may further include creases or grooves formed therein, for example with an ultrasonic or RF welding die. For example, the stamping and heating action of an RF sealing die imparts a small indentation at the bond point that can be used to help guide corrugation. Smaller indentations or grooves can be incorporated at various points by modification of the RF die.

For embodiments wherein bond points are formed using adhesives or solvents, grooves may optionally be added to the non-shrinkable core layers to help keep the adhesive or solvent within a specific area and prevent “squeeze-out” when the layers are pressed together. Other modifications such as pre-creasing, slitting, scoring, die-cutting, thermal pre-forming, localized annealing, etc., might also be used to aid in guiding formation of the corrugations in certain applications. Similarly, the use of selective heating to soften certain points along the non-shrinkable core layers may be beneficial, as softening the material has the same effect as reducing the local thickness. For example, dyes or other electromagnetic radiation absorbers might be selectively added/printed on certain sections of the non-shrinkable core layers to make those sections heat up more, to further control the corrugation process. In one embodiment, the adhesive itself used to form the bond points includes a radiation absorbing additive or is otherwise modified to be more absorbent to radiation, reducing the modulus of the core layer on radiative heating at the bond point thereby reducing resistance to buckling. The non-shrinkable core layers may include flutes or cut-outs to better allow for formation of corrugations. As the shrinkable film layers shrinks and pulls in, the flutes in the non-shrinkable cores pull together and close the gap to result in more continuous core layers.

The shrinkable film layers 50 and 60 may be comprised of a variety of film materials with the material for each layer individually selected from a variety of polymer components having selected physical properties such as glass transition temperature, tensile modulus, melting point, surface tension, and melt viscosity. Examples include one or more of a polyester, a copolyester, an acrylic, a polyvinyl chloride, a polylactic acid, a polycarbonate, a styrenic polymer, a polyolefin, a polyamide, a polyimide, a polyketone, a fluoropolymer, PVC, a polyacetal, a cellulose ester or a polysulfone. Shrinkable film layers may also be formed from, for example, polyesters of various compositions. For example, amorphous or semicrystalline polyesters may be used which comprise one or more diacid residues of terephthalic acid, naphthalene-dicarboxylic acid, 1,4 cyclohexane-dicarboxylic acid, or isophthalic acid, and one or more diol residues, for example ethylene glycol, 1,4-cyclohexane-dimethanol, neopentyl glycol, or diethylene glycol. Additional modifying acids and diols may be used to vary the properties of the film as desired. In a preferred embodiment, shrinkage of the shrinkable film layers 50 and 60 is activatable by elevated temperature or heating. The thickness of the shrinkable layers can range, for example, from 0.01 mm to 10 mm. Because of the potential for excessive wrinkling at thinner gauges, it may be preferred that the thickness of the shrinkable layers range from 0.05 to 5 mm, or more preferably from 0.1 to 5 mm, or even more preferably from 0.2 to 2 mm.

The shrinkable film layers of the present invention may be produced by methods generally similar to the non-shrinkable core layers, but are characterized in that the film will also typically be oriented in a preferred embodiment wherein shrinkage is activatable by heating. The term “oriented”, as used herein, means that the shrinkable film layer is stretched to impart direction or orientation in the polymer chains. The shrinkable film layer, thus, may be “uniaxially stretched”, meaning the shrinkable film layer is stretched predominantly in one direction, or “biaxially stretched,” meaning the shrinkable film layer has been stretched in two different directions, one of which is the major or primary axis of shrinkage. Typically, the two directions are substantially perpendicular. For example, in the case of a film, the two directions are in the longitudinal or machine direction (“MD”) of the film (the direction in which the film is produced on a film-making machine) and the transverse direction (“TD”) of the film (the direction perpendicular to the MD of the film). Biaxially stretched articles may be sequentially stretched, simultaneously stretched, or stretched by some combination of simultaneous and sequential stretching. The shrinkable film layers according to the present invention are characterized as having a primary axis of shrinkage, although they may have an additional secondary axis of shrinkage. In a preferred embodiment, the shrink layers are uniaxially oriented with the resulting singular axis of shrinkage being the primary axis of shrinkage.

Orientation can be achieved by traditional stretching on a tenter, drafter or blown film, or it can be imparted as part of a traditional process such as calendering. Because the present invention may be characterized in certain embodiments by relatively low shrinkages, it is also possible to make sufficiently oriented films on, for example, a traditional cast line, by using high draw down speeds and rapid quenching of the film.

The properties of the final product depend on and can be controlled by manipulating the stretching time and temperature and the type and degree of stretch. The stretching typically is done just above the glass transition temperature (e.g., Tg+5° C. to Tg+60° C.) of the polymer matrix.

It is also understood that the shrinkable “film” layers can also be a woven or nonwoven structure such as a web or fabric containing shrinkable fibers so long as the shrinkage and shrink force of the fibers is sufficient to induce the necessary corrugation.

In another embodiment, one or more of the shrinkable film layers can be formed from a stretchable rubber-like material such as natural rubber, styrene-butadiene rubber, thermoplastic elastomers, stretchable fabrics and woven structures and the like held by stretching forces in a stretched configuration. In this embodiment, the shrinkable film layers are manually held in their stretched configuration while bonding to the non-shrinkable core layers occurs and the stretching forces are released to cause corrugation. In a similar manner, shrinkable film layers activated by other stimuli (e.g. moisture contact) are also envisioned.

According to one aspect of the invention, we have determined that providing a relatively low amount of shrinkage in the shrinkable film layers as reflect by percent may assist in obtaining uniform structural corrugations. The shrinkable film layers typically are each characterized by a percent shrinkage as calculated below in the range of about 8% to about 48%, preferably 10 to 45%, more preferably 15 to 40%, and even more preferably 20 to 40% as measured along the primary axis of shrinkage of the shrinkable film layer. Percent shrinkage is defined as the percentage of length lost upon activation of shrinkage, for example upon heating, using the following formula:

Percent shrinkage=(Lo−L)/Lo*100 (1)

wherein L is the length of a shrinkable film layer after shrinkage, and Lo is the length of the shrinkable film layer prior to shrinkage. Percent shrinkage refers to the amount of shrinkage along the primary axis and may be measured in heat-shrinkable film by heating the film to a temperature sufficiently above the Tg (or the melting temperature Tm, if crystalline) to allow substantially complete recovery of the film. By the term “length,” we mean generally the primary direction in which, for example, a heat-shrinkable film layer was formed, although such a film may be stretched biaxially or radially, for example. We note that an equi-biaxially oriented film and a radially stretched film are essentially equivalent from a mechanical perspective. Uniaxial film can be formed by stretching in the machine direction with, for example, a drafter or calender, or in the transverse direction with a tenter frame. Combining the two processes results in biaxially-oriented film. Some processes, like blown film, provide shrinkage in both the machine and transverse directions simultaneously, although the shrinkage is usually much higher in one direction. The length may thus be in the shrinkage direction of axis of shrinkage for uniaxial film and either or both directions when biaxial film layers are described. Although most commercial shrink films used for packaging have an ultimate or total shrinkage of 60 to 80%, we have found that high shrinkage from these conventional films produces poorly formed and uncontrolled corrugations (i.e. “wrinkling” or “overbuckling”). As a result of much experimentation and analysis, it was discovered that the preferred ranges of shrinkage for producing desirably uniformly corrugated structures are as set forth herein. Outside of these ranges, either wrinkling or insufficient buckling may occur, such that it may be difficult to create stable and consistent structural corrugations. Even in cases where we were able to achieve acceptable structures using high shrinkage shrinkable film layers, by only partially shrinking the shrinkable film layers, the resulting structures were not thermally stable as any additional heating would cause the corrugation to be disrupted.

It should be understood that the upper and lower shrinkable film layers need not exhibit the same percent shrinkage, especially if curved corrugated structures are desired. For example, the upper shrinkable film layer may have about 10% shrinkage, while the lower shrinkable film layer may exhibit about a 20% shrinkage. In such cases, differential shrinkage may be an important aspect of obtaining curved corrugated structures with the difference in shrinkage between the layers along their respective primary axes of shrinkage being useful in controlling the radius of curvature of the curved corrugated structure.

As discussed above, first non-shrinkable core layers 20 and second non-shrinkable core layer 30 are bonded together in a grid 35 of spaced bond points 40 arranged substantially linearly along perpendicular horizontal (or x-direction) and vertical (or y-direction) bond point lines 42 and 44 respectively. Spacing between spaced bond points 40 is indicated as Pox along horizontal bond point line 42 and Poy along vertical bond point line 44. In a first embodiment, the spacing between the spaced bond points 40 along the horizontal bond point line 42 is substantially the same as the spacing between the spaced bond points 40 along the vertical bond point line 44. In a second embodiment the spacing between said spaced bond points 40 along said horizontal bond point line 42 is greater than the spacing between said spaced bond points 40 along said vertical bond point line 44.

In general, the bond spacing is selected based on a variety of a factors, including the desired size and shape of the corrugations to be formed and the geometry of the films during shrinkage of the shrinkable film layers, with the generally linear bond point lines resulting in generally linear lines of corrugation and structural corrugations without excessive wrinkling in the resulting corrugated structure. Wider bond point spacing generally leads to structural corrugations having a greater height, while narrower bond point spacings will generally result in corrugations having a relatively lower height, as further described herein, with the height of the corrugation depending upon the distance between the bonds in the direction perpendicular to the primary axis of shrinkage of a given shrinkable film layer.

Though spacing between spaced bond points 40 is preferably equal along a bond point line, it should be understood that the spacing between the spaced bond points can optionally vary along said horizontal bond point line 42 or said vertical bond line 44 or both bond point lines 42 and 44.

Spaced bond points 40 may be formed any one or more of a number of different bonding methods. For example, bond points 40 may include an adhesive or adhesive-containing material such as tape. Typical adhesives that may be used include epoxies, urethanes, hot melts, acrylic-based adhesives, cyanoacrylates, UV-activated adhesives and the like. Spaced bond points 40 may also include welds such as may be formed for example by thermal bonding, RF sealing, induction welding, laser welding, ultrasonic welding, solvent welding and the like. Because of the modular nature of the self-corrugating laminates of the present invention, the bonding for bond points is particularly amenable to RF sealing, ultrasonic welding, and other similar energy-based methods as the bonding is easily patterned and occurs very quickly. This makes manufacturing of the article much more efficient and cost effective as well as typically providing stronger bonds.

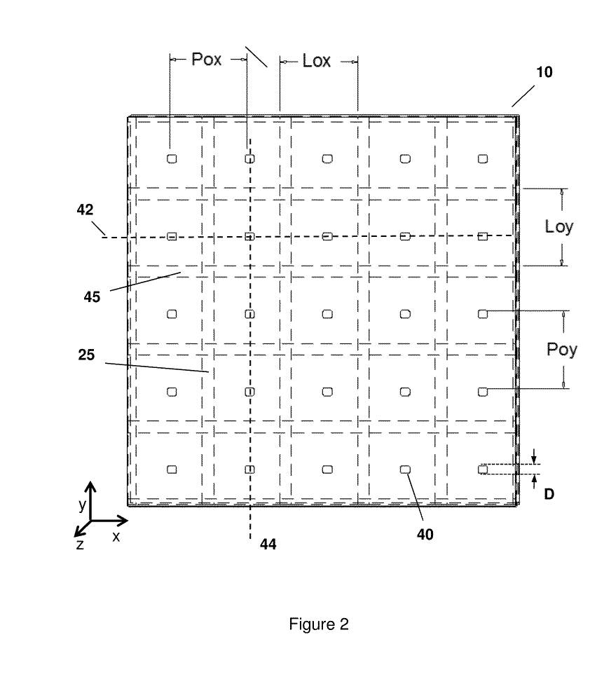

The spaced bond points 40 should be of sufficient area to ensure adequate strength but not so large a surface area as to adversely affect the corrugation process described below. With reference to FIG. 2, if D is a characteristic dimension of the bond point 40 (e.g. the diameter of a circular bond or the width of a square or substantially square bond point) then it is preferred that the ratio of D/Po (where Po equals Pox or Poy as set forth above) be from about 0.01 to about 0.4, or more preferably from 0.03 to 0.3.

The shape of the individual bond points 40 can be of any geometry, whether substantially square, rectangular, circular, or substantially circular in shape. We have found that sharp corners such as might be induced by square bond point geometries, might serve as notches, leading to tearing of the layers bonded thereby, so bond points with liberally rounded or radiused corners may be preferred. The bond points may optionally be scored to contain grooves or creases to assist with the formation of corrugations upon shrinkage of the two shrinkable film layers as described below.

When we say that the two non-shrinkable core layers are bonded together in a grid of spaced bond points arranged substantially linearly along perpendicular horizontal and vertical bond point lines, we mean to include arrangements in which the bond points define a strict bond point line, as well as cases in which the bond points may not define a strict line, but rather may vary somewhat along a linear bond point array, so long as the desired corrugated structure is obtained. Of course, the degree to which the bond points are linearly arranged will correspondingly affect the degree of linearity of the resulting structural corrugations in the corrugated structure. We mean therefore simply to encompass self-corrugating laminates in which the horizontal and vertical bond point lines and their intersections are not absolutely geometric, so long as the desired result is obtained.

As noted elsewhere herein, upper shrinkable film layer 50 is bonded to the exposed surface 22 of first non-shrinkable core layer 20 along upper bond lines 25 and similarly lower shrinkable film layer 60 is bonded to the exposed surface 32 of the lower non-shrinkable core layer 30 along lower bond lines 45. Spacing between upper bond lines 25, or upper bond line spacing, is indicated as Lox where spacing between lower bond lines 45, or lower bond line spacing, is shown as Loy.

Bond lines 25 and 45 may be formed any one or more of a number of different bonding methods. For example, bond lines 25 and 45 may include an adhesive or adhesive-containing material such as tape. Typical adhesives that may be used include epoxies, urethanes, hot melts, acrylic-based adhesives, cyanoacrylates, UV-activated adhesives and the like. Bond lines 25 and 45 may also include welds such as may be formed for example by thermal bonding, RF sealing, induction welding, laser welding, ultrasonic welding, solvent welding and the like. Because of the modular nature of the self-corrugating laminates of the present invention, bonding for bond lines is particularly amenable to RF sealing, ultrasonic welding, and other similar energy-based methods as the bonding is easily patterned and occurs very quickly. This makes manufacturing of the article much more efficient and cost effective as well as typically providing stronger bonds. As used herein, the term “bond lines” means continuous or discontinuous bonding which is generally linear or curved, and may be a continuous line or a noncontinuous line, for example a line or curve comprised of spot welding, arranged with respect to adjacent bond lines. Spot welds are acceptable, but they preferably are reasonably close together so that distortion does not occur.

To achieve desirable corrugated structures from the self-corrugated laminate, it is preferred that horizontal bond point lines 42 are oriented substantially parallel to and staggered with respect to upper bond lines 25. Similarly, it is preferred that vertical bond point lines 44 are oriented substantially parallel to and staggered with respect to lower bond lines 45. “Staggered” as used herein means that bond point lines are located generally between adjacent bond lines, most preferably at a distance of about half the adjacent bond line spacing. In a preferred embodiment, bond spacing between bond points along horizontal bond point lines is approximately equal to upper bond line spacing Lox. Similarly, bond spacing between bond points along vertical bond point line is approximately equal to lower bond line spacing Loy. Thus, approximately Pox=Lox and Poy=Loy. For embodiments described above wherein bond point spacing varies along a given bond point line, it is therefore preferred that corresponding bond line spacings vary approximately the same amount. Most preferably, bond point spacing, upper bond line spacing and lower bond line spacing are approximately equal.

We have unexpectedly discovered that a useful corrugated structure maybe formed from the self-corrugating laminate of the present invention. More particularly, upon shrinkage of said upper and lower shrinkable film layers, a corrugated structure comprising structural corrugations in said first and second non-shrinkable core layers is formed. Upon activating the shrinkage in the upper and lower shrinkable film layers, corrugations are formed in the first and second non-shrinkable core layers along lines of corrugation that are perpendicular to one another, forming a cross-ply corrugated structure. This cross-ply corrugation has the benefit of being much more rigid in both the machine direction (MD) and transverse direction (TD) as compared with structures of the prior art.

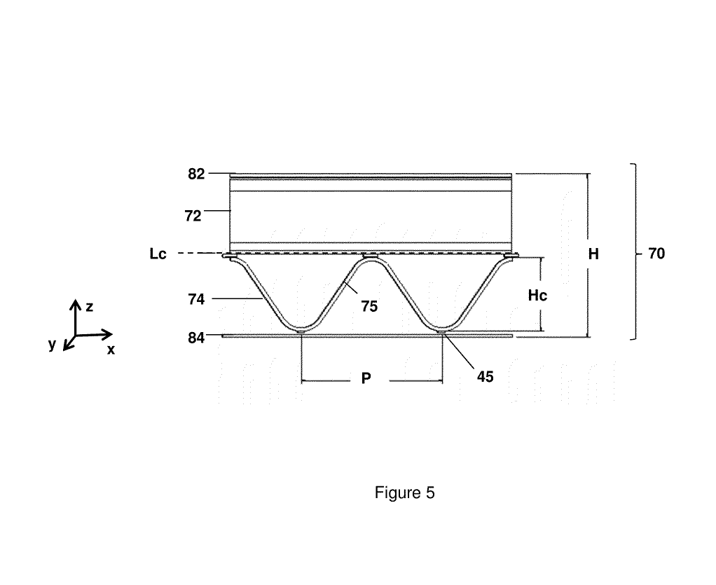

The two outer shrinkable film layers, in effect, corrugate the inner core layers to which they are bonded upon activation of their shrinkage, forming a cross-ply structure, while the outer shrink layers provide inherently protective outer film layers for the corrugated structure. More particularly, shrinkage of each of the first and second shrinkable film layers causes each of the respective adjacent core layers to buckle to form corrugations along lines of corrugation that are generally perpendicular to the axis of shrinkage of the adjacent shrinkable film layer. The buckling action is due in part to the constraints imposed by the bond points resisting the contraction force imposed by shrinkage of the shrinkable film layers. The initial bond spacing Pox (or Poy) in the self-corrugating laminate translates after shrinkage of the shrinkable film layers to corrugation spacing Px (or Py) as depicted in FIG. 5. The height of each structural corrugation is denoted by Hc with the total thickness of the corrugated structure subsequent to shrinkage of the shrinkable film layers equal to H.

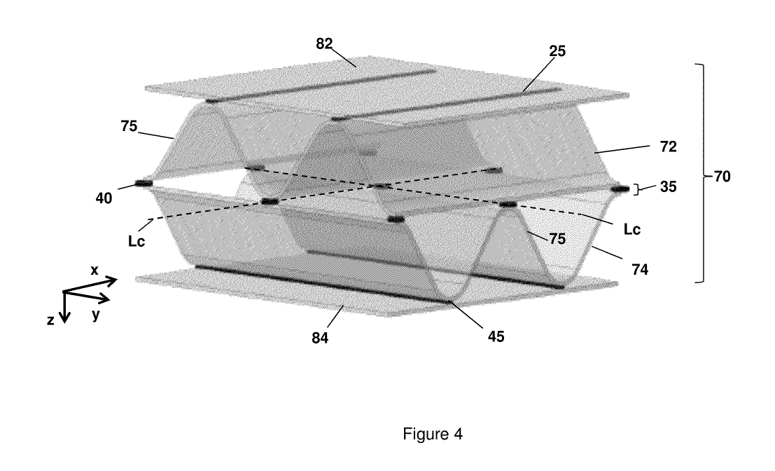

A corrugated structure of the present invention, formed from a self-corrugating laminate of the present invention is therefore generally shown at 70 in FIGS. 4 and 5. Corrugated structure 70 includes first and second core layers 72 and 74, each having spaced structural corrugations 75 formed therein along lines of corrugation Lc. The lines of corrugation of the structural corrugations 75 in the first core layer 72 are substantially perpendicular to the lines of corrugation of the structural corrugations 75 in the second core layer 74. The corrugated structure further includes a first film layer 82 bonded to the first core layer 72 and a second film layer 84 bonded to second core layer 74. Film layer 82 is bonded to first core layer 72 along the upper bond lines 25 that bonds upper shrinkable film layer 50 to core layer 20 in the self-corrugating laminate. Similarly film layer 84 is bonded to second core layer 74 along the lower bond lines 45 that bonds lower shrinkable film layer 60 to core layer 30 in the self-corrugating laminate.

As the corrugated structure of the present invention is formed from the self-corrugating laminate of the present invention upon activation of the shrinkage in the shrinkable film layers, it should be understood that core layers 72 and 74 may be formed from the same materials as the non-shrinkable core layers 20 and 30 while film layers 82 and 84 may be formed from the same materials as shrinkable film layers 50 and 60.

As shown in FIGS. 4 and 5, the spaced structural corrugations 75 in a given core layer are arranged along lines of corrugation Lc that are, for that core layer, generally parallel in form, with that core layer in cross-section having the general appearance of a sine wave, and when viewed from above having wave-like peaks and troughs. Accordingly, the lines of corrugation for corrugations 75 in the first core layer 72 are substantially parallel to one another and the lines of corrugation for corrugations in the second core layer 74 are substantially parallel to one another. The lines of corrugation of the structural corrugations 75 in the first core layer 72 are substantially perpendicular to the lines of corrugation for the structural corrugations 75 in the second core layer 74.

In one preferred embodiment, the invention thus relates to a self-corrugating flat laminate film structure having at least four layers, and comprising two outer uniaxial shrinkable film layers, each bonded to an inner core layer such that the primary axes of the two shrinkable film layers are substantially perpendicular to one another, and such that when the film layers shrink, corrugations are thereby formed in the core layers that are themselves perpendicular to one another, in effect forming a cross-ply corrugated structure. This resulting four-layer corrugated structure may be termed a “corrugation module” or a “base corrugation model” herein, and is the simplest and most basic form of the present invention. These corrugation modules can, in turn, be combined together or modified to create additional structures. The self-corrugating laminate films of the invention are by no means limited to four layers, but may be formed of any number of additional layers that may, depending on the intended use, be bonded such that the axes of shrinkage of the shrinkable film layers are parallel, perpendicular, or some combination of the two, as the case may be.

More particularly, the self-corrugating laminates of the invention, and therefore the corrugated structures of the present invention, may optionally have any number of additional layers. For embodiments of the self-corrugating laminates that include additional layers, such layers are preferably bonded to at least one of the shrinkable film layers. This bonding preferably takes place after shrinkage and corrugation of the self-corrugating laminate has occurred to form the corrugated structure. An example of this is the bonding of fiberglass skin layers to provide even greater flexural rigidity. It should be understood that the characteristics of any additional layers and their bonding should be selected in order to be at worst neutral and preferably advantageous to the shrinkage of the shrinkable film layers and desirable formation of corrugations in a resulting corrugated structure. For embodiments of the corrugated structure that include additional layers, such layers are preferably bonded to at least one of the film layers 82 and 84.

According to one aspect of the present invention, particularly uniform and strong corrugated structures may be characterized by an aspect ratio that preferably is indicative of a substantially sinusoidal pattern. The aspect ratio is defined as the ratio Hc/P where Hc is the height of a given structural corrugation in a core layer and P is the corrugation spacing in either the x or y direction (Pₓ or P_{y}) (analogously, Hc is twice the amplitude of the sine wave represented by the corrugation and P is the corrugation wavelength). If Hc/P is too large, then the resulting corrugation is very “tall” and closely packed together resulting in a more unstable structure. In this case, compressive strength (i.e. top load) is adequate but shear resistance is less than might be desirable. This is also typical of the corrugations formed when film shrinkage is too high. Conversely, if Hc/P is too low, the corrugation is too shallow and widely spaced and provides little compressive strength from top loads (but good shear resistance). For uniform corrugated structures, the aspect ratio is generally the same within and across its core layers. It should be understood, however, that because Pₓ, P_{y} and Hc can vary within a corrugated structure, the ratio of Hc/P (i.e. H_{c}/Pₓ or H_{c}/P_{y}) can also be vary such that a corrugated structure of the present invention may be characterized by multiple aspect ratios.

Preferred corrugated structures of the present invention have aspect ratios of preferably within the range of from about 0.1 to about 0.8 according to the following formula:

0.1<Hc/P<0.8 (2)

A more preferred range for the aspect ratios is from about 0.2 to about 0.6, as this range is generally applicable to a corrugated structure formed from a self-corrugating laminate with shrinkable film layers having present shrinkages of from about 15% to about 40%.

Curved or 3-D structures can also be generated by forming or shaping the self-corrugating laminate or corrugated structure using a mold or guide tooling. This can be done as part of the shrinkage process, where the self-corrugating laminate part is pushed into a new geometry as it shrinks and corrugates. Alternately, the corrugated structure can be shaped in a secondary operation using, for example, a thermoforming process.

The present invention thus provides a way to make a corrugated structure from a preformed, preferably substantially flat self-corrugating laminate that preferably can be rolled for ease of shipping and storage and then unrolled and processed as needed to form a corrugated structure.

Construction of the self-corrugating laminates of the present invention can be achieved in a number of different ways. In assembling and constructing the self-corrugating laminate of the present invention, the upper and lower shrinkable film layers are each bonded to the exposed surface of first and second non-shrinkable cores respectively layer along bond lines and the first and second core layers are bonded to each other in a grid of spaced bond points arranged substantially linearly along perpendicular horizontal and vertical bond point lines. In order to generate the desired structural corrugations in the non-shrinkable core layers upon shrinkage of the shrinkable film layers, the horizontal bond point lines are preferably oriented substantially parallel to and staggered with respect to upper bond lines and vertical bond point lines are preferably oriented substantially parallel to and staggered with respect to lower bond lines. This bonding can be performed by any number of batch, semicontinuous or continuous methods. For example, the self-corrugating laminate may be constructed using a continuous process (e.g. a roll-to-roll process) that includes (i) feeding first and second non-shrinkable core layers from rolls to form a core assembly; (ii) bonding first and second non-shrinkable cores to form a bonded core assembly; (iii) feeding the bonded core assembly, upper shrinkable film layer and lower shrinkable film layer, to form a laminate assembly; and (iv) bonding upper shrinkable film layer to the exposed surface first non-shrinkable core and lower shrinkable film layer to the exposed surface of second non-shrinkable core. Another example could include (i) feeding upper shrinkable film layer and first non-shrinkable core to form a first prelam; (ii) bonding upper shrinkable film layer to the exposed surface of the first non-shrinkable core to form a first bonded prelam; (iii) feeding lower shrinkable film layer and second non-shrinkable core to form a second prelam; (iv) bonding lower shrinkable film layer to the exposed surface of the second non-shrinkable core to form a second bonded prelam; and (v) bonding the first and second bonded prelams at the first and second non-shrinkable cores. Typically, the upper and lower prelams produced in steps (i) and (iv) respectively can be fed from the same master roll. It is only required that the second or lower prelam be properly oriented relative to the first or upper prelam prior to the final bonding step (v). The resulting self-corrugating laminate could then be wound into a roll for later use, or cut to length to form individual laminates. Such roll-supply process can be operated to provide in-line orientation to the shrinkable film layers typically by using draw rolls of variable speed. The various layers can be brought together and bonded by, for example, an embossing type roll or inline welder, and then either treated to form a corrugated structure or wound up on a roll for shipping or storage.

Alternatively, the laminate may be constructed using a manual/batch process such as a “cut and stack” operation.

The self-corrugating laminates of the present invention are useful in forming corrugated structures. Another aspect of the present invention, therefore, is a method for forming a corrugated structure. This method of the present invention includes procuring, for example through manufacture or commercial transaction, a self-corrugating laminate of the present invention and subjecting the self-corrugating laminate to conditions sufficient to impart corrugation to the first and second non-shrinkable cores of the laminate.

Preferably, the shrinkage of the upper and lower heat shrinkable film layers is activatable by elevated temperature or heat. In this preferred embodiment, the subjecting step includes exposing the shrinkable film layers of the self-corrugating laminate to a temperature sufficient to cause shrinkage of both shrinkable film layers. Typically, this temperature is a temperature at or above the shrinkage temperature of both shrinkable film layers assuming for convenience and without limitation that the shrinkable film layers are formed from the same material. By way of example, the temperature for the exposing step should preferably be in the range of Tg−10° C. to about Tg+30° C. where the Tg is for the shrinkable layer. Higher temperatures will also provide good quality corrugation, but greater care must be taken to ensure uniform heating in order to minimize curling/warping. If different materials are used in forming the shrinkable film layers, the temperature for the exposing step is preferably set based on the highest Tg between and amongst the shrinkable films.

While not required, it is generally preferred that the temperature of the exposing step employed in the method of the present invention not exceed the softening temperature of the materials from which the non-shrinkable core layers are formed. It can be important that the core layers be of consistent modulus during the process in order to ensure uniform corrugation. If, for example, the core Tg is similar the shrinkage temperature, then the core could be prone to softening and modulus variation which could result in uneven corrugation, unless very precise temperature control is employed. Generally, however, it is acceptable if the softening temperature of the non-shrinkable core layers is below the temperature employed in the method of the present invention.

The step of exposing the shrinkable film layers of the self-corrugating laminate to a temperature causing them to shrink can be effected by any suitable means and/or media known in the art, for example hot air exposure, immersion in a hot fluid, steam exposure etc. It is also possible to employ in the exposing step electromagnetic field methods such as IR, electromagnetic or conductive heating in embodiments where the shrinkable film layers are formed from a material sufficiently susceptible to temperature increases via an imposed energy source. By way of example, the presence of an IR absorber as a component of the shrinkable film layers might promote shrinkage of the shrinkable film layers when exposed to infrared heaters while leaving the non-shrinkable core at a relatively lower temperature.

For embodiments where a curved or otherwise shaped corrugated structure is desired, the process for forming the corrugated structure can further include shaping the corrugated structure. In a first embodiment the shaping step is performed simultaneously with the temperature exposure step, most preferably with the temperature exposure step performed in the presence of a mold or other shaping device which shapes the overall structure while not impacting the corrugation of the non-shrinkable cores achieved by the temperature exposure step. In another embodiment, the shaping step is performed subsequent to the temperature exposure step. We have observed that a particularly suitable corrugated structure can be achieved when the laminate is placed in a hot mold for the temperature exposing step and allowed to form with only very light mold pressure to guide the overall structure. In this situation, corrugation is activated by the elevated temperature of the mold and occurs simultaneously with molding as the overall structure softens and is pushed against the mold tooling.

It will be understood by one of ordinary skill that composite corrugated structures that include two or more individual corrugated structures of the present invention may be contemplated. For example, a composite corrugated “stack” that includes multiple corrugated structures, with each corrugated structure formed from the self-corrugating laminate of the present invention, can be formed. The individual corrugated structures can be built together as a continuous stack or be individual corrugated structures laminated together. Furthermore, each structure in the stack can have differing geometries and/or preferred orientations from others. For example, one structure in the stack might be oriented perpendicular to another in a cross ply configuration, or at 45 degree angles in a bias ply in order to provide more flexural rigidity. Depending in part on the orientation of the individual structures and their components, a stack can also be formed by assembling two or more self-corrugating laminates and subjecting the assembled laminates to corrugation conditions as a single unit. Alternatively, individual self-corrugating laminates can be subjected to corrugation conditions separately and then bonded or laminated together to form a stack.

According to various embodiments, the shrinkable film layers and the non-shrinkable core layers can optionally be modified to include or compose various functionalities. For example, the non-shrinkable core layers can be printed or decorated to provide aesthetic properties. Distortion printing might be preferred to ensure proper artistic definition in the final corrugated structure. The shrinkable film layers could also include functionalities such as decorative printing for aesthetics.

The non-shrinkable core layers can also be modified to include or incorporate other features such as conduits, electrical conductive networks (e.g. flexible circuits), RF shielding via metallized coatings, fibrous structures for filtration, and so forth. These can be directly added into or onto the non-shrinkable core layers, or sections of the core could be removed prior to corrugation to allow for these features to be added. In one embodiment, flexible circuits consisting of etched copper coated polyimide could be laminated to portions of the non-shrinkable core layers to provide embedded wiring in the resulting corrugated structure. In addition to the core layers, other separate components can also be integrated between the film layers prior to subjecting the laminate to corrugation conditions.

The non-shrinkable core layers can also contain reinforcing materials such as fiber/flake reinforcement for embodiments where particularly demanding structural applications are intended. These can be an integral part of the core or added on via adhesion or lamination. Various structural applications of the corrugated structure such as panels, furniture, partitions, etc. can be envisioned. Reinforcement within the shrinkable film layers is also envisioned although it should be understood that such reinforcement should not adversely impact the stretching/orientation process for making the film or the effectiveness of shrinkage activation.

The corrugated structure formed from the self-corrugating laminate can also include optical elements such as OLED, phosphorescent layers, fluorescent materials, liquid crystal layers, etc. and serve as an optical device or light guide.

There are numerous structural and functional applications of such a structure and the above list is not meant to be limiting. Instead, the self-corrugating laminates and resulting corrugated structures are meant to be building blocks to enable a wide range of new structures and allow for an entirely new manufacturing method.

### EXAMPLES

The following experimental methods were used to characterize the various self-corrugating laminates, their components and related corrugated structures.

Shrinkage for shrinkable films was determined by immersing a 100 mm×100 mm sample of the shrinkable film sample in water at 95° C. Hot water was used because copolyester shrink films (Tg=72° C.) were used for the experiments. The film was held in the bath for at least 30 seconds to ensure full shrinkage was complete. The length of the sample was then measured and the shrinkage along the primary axis of shrinkage determined by the following formula:

Percent shrinkage=(Lo−L)/Lo*100 (1)

in which L is the length after shrinkage and Lo is the initial length (100 mm). For shrink films having a Tg>100° C., hot water can no longer be used, so either hot oil or hot air is required. For these tests, the temperature of shrinkage should be at least Tg+20° C. and the sample held until full shrinkage is acquired. This is typically about 30 seconds for liquid media and 1 minute for hot air ovens.

### Example 1

### Production of a Corrugation Module

For this example, a uniaxially stretched copolyester film made from Eastman Embrace LV™ (Eastman Chemical Company, Kingsport, Tenn.) was used as the upper and lower shrinkable film layers. This resin is commonly used for shrink packaging and has a Tg=72° C. To make the shrink film, a cast film 0.18 mm thick was extruded to create the unoriented base material. This film was then stretched 1.5× on tenter frame at a nominal temperature of 82° C. resulting in an ultimate shrinkage of 34% along the primary axis of shrinkage, and a final thickness of 0.14 mm.

The first and second non-shrinkable core layers consisted of 0.10 mm unoriented film made from Eastman Tritan™ copolyester. Two square pieces of each film type were cut having nominal dimensions of 150×150 mm.

In the first step of assembly, a shrinkable film layer was RF welded along a horizontal bond lines to a non-shrinkable core layer using a 10 kW Kabar RF sealer to form a “pre-lam” that included a shrinkable film layer bonded to a non-shrinkable core layer along bond lines. A brass die tool was used having a spacing Lox=20 mm between bond lines and a nominal bond line width of 4 mm. The bond lines extended across the full width of the film samples and were perpendicular to the axis or shrinkage of the shrinkable film layer. This process was then repeated to create a second “pre-lam”.

Next, the two pre-lams were bonded together. To accomplish this, the two pre-lams were arranged such that their respective axes of shrinkage were normal to each other, and the non-shrinkable core layers faced each other. Spaced bond points were then formed by spot bonding (Pₒ=Pₒₓ=P_{oy}=25.4 mm) using pieces of 3M VHB™ tape nominally 5 mm square. Tape squares were mounted in the center of crossing RF seal bond lines. After tape was applied, the layers were pressed together in a Carver press using light pressure to ensure good adhesion and form the self-corrugating laminate.

Upon completion of the self-corrugating laminate as described above, the sample was then exposed to steam to induce corrugation. The steam was supplied by a modified paint stripper plumbed into a metal pot. The laminate sample was placed into the steam pot, and allowed to shrink/corrugate for about 15 to 30 seconds. Upon removal, the sample was observed to have core layers with nice, well-defined corrugation in each direction with a new periodic spacing Pₓ=P_{y}=15 mm and a corrugation height H_{c}=4 mm. The sample was both flexurally rigid and aesthetically pleasing.

### Example 2

### Curved Sample

In this prophetic example, the same procedure and material is used as in Example 1, except the upper shrinkable film layer has a shrinkage along the primary axis of shrinkage of 34% and the lower shrinkable film layer has a percent shrinkage along the primary axis of shrinkage of 40%. Upon heating to active shrinkage, this sample formed a curved corrugated structure due to differential shrinkage between the shrinkable film layers.

That which is claimed is:

1. A self-corrugating laminate comprising:
First and second non-shrinkable core layers bonded together in a grid of spaced bond points arranged substantially linearly along perpendicular horizontal and vertical bond point lines; each of said non-shrinkable core layers comprising an exposed surface;
an upper shrinkable film layer having a primary axis of shrinkage, said upper shrinkable film layer bonded to said exposed surface of said first non-shrinkable core layer along upper bond lines arranged substantially parallel to one another and substantially perpendicular to said primary axis of shrinkage of said upper shrinkable film layer; and
a lower shrinkable film layer having a primary axis of shrinkage, said lower shrinkable film layer bonded to said exposed surface of said second non-shrinkable core layer along lower bond lines arranged substantially parallel to one another and substantially perpendicular to said primary axis of shrinkage of said lower shrinkable film layer.

2. The self-corrugating laminate of claim 1 wherein said axis of shrinkage of said upper shrinkable film later is substantially normal to said axis of shrinkage of said lower shrinkable film layer.

3. The self-corrugating laminate of claim 1 wherein, upon shrinkage of said upper and lower shrinkable film layers, a corrugated structure comprising structural corrugations in said first and second non-shrinkable core layers is formed.

4. The self-corrugating laminate of claim 1, wherein the spacing between said the spaced bond points along said horizontal bond point lines is substantially the same as the spacing between said spaced bond points along said vertical bond point lines.

5. The self-corrugating laminate of claim 1, wherein the spacing between said spaced bond points along said horizontal bond point line is greater than the spacing between said spaced bond points along said vertical bond point line.

6. The self-corrugating laminate of claim 1, wherein the spacing between said bond points varies along said horizontal bond point line or said vertical bond line or both bond point lines.

7. The self-corrugating laminate of claim 1, wherein said upper and lower shrinkable film layers each exhibit a percent shrinkage in the range from 15 to 45 percent.

8. The self-corrugating laminate of claim 1, wherein said upper and lower shrinkable film layers are each individually formed from one or more of a polyester, a copolyester, an acrylic, polyvinyl chloride, polylactic acid, a polycarbonate, a styrenic polymer, a polyolefin, a polyamide, a polyimide, a polyketone, a fluoropolymer, a polyacetal, a cellulose ester and a polysulfone.

9. The self-corrugating laminate of claim 1, wherein said spaced bond points comprise an adhesive.

10. The self-corrugating laminate of claim 1, wherein said spaced bond points comprise welds formed by RF sealing, ultrasonic bonding, laser welding, heat welding, solvent welding or induction welding.

11. The self-corrugating laminate of claim 1, wherein the bond lines comprise an adhesive.

12. The self-corrugating laminate of claim 1, wherein the bond lines comprise welds formed by RF sealing, ultrasonic bonding, laser welding, heat welding, solvent welding or induction welding.

13. The self-corrugating laminate of claim 1 wherein said horizontal bond point lines are oriented substantially parallel to and staggered with respect to said upper bond lines and said vertical bond point lines are oriented substantially parallel to and staggered with respect to said lower bond lines.

14. A corrugated structure formed from the self-corrugating laminate of claim 1.

15. The corrugated structure of claim 13 wherein said structure comprises first and second core layers each having spaced structural corrugations formed therein along lines of corrugation.

16. The corrugated structure of claim 15 wherein said lines of corrugation for said structural corrugations in said first core layer are substantially perpendicular to said lines of corrugation of said structural corrugations in said second core layer.
